(19) United States
(12) Patent Application Publication
(10) Pub. No.: US 2010/0270479 A1
(43) Pub. Date: Oct. 28, 2010

(54) NON-IMAGING, WEAKLY FOCUSED FLUORESCENCE EMISSION APPARATUS AND METHOD

(75) Inventors: Watt W. Webb, Ithaca, NY (US); Chris Xu, Ithaca, NY (US)

Correspondence Address: BOND, SCHOENECK & KING, PLLC, 10 BROWN ROAD, SUITE 201, ITHACA, NY, 14850-1248, US

(73) Assignee: CORNELL UNIVERSITY, Ithaca, NY (US)

(21) Appl. No.: 12/742,575

(22) PCT Filed: Nov. 12, 2008
(86) PCT No.: PCT/US2008/083174

§ 371 Date: May 12, 2010

Related U.S. Application Data
(60) Provisional application No. 60/987,270, filed on Nov. 12, 2007.

(51) Int. Cl. G01N 21/64

(52) U.S. Cl. 250/459.1; 250/458.1

(57) ABSTRACT

Apparatus and methods relating to non-imaging, multiphoton fluorescence and optical second harmonic generation (SHG) (and higher harmonic generation) emission and detection. A weakly focused excitation beam is used to generate fluorescence emission in a volume of between about 0.1 cm³ to one cubic centimeter (1 cm³), which is significantly larger than the conventional MPM focal volume. A method for shaping and/or controlling (confining) the focal volume of a non-imaging, fluorescence emission excitation field in a target medium involves decoupling the axial dimension dependence of the focal volume from the lateral spot size of the excitation field. The method involves the step of spatially separating at least some of the spectral components of a short duration, multichromatic excitation field outside of the focal volume and spatially recombining the spectral components in a short duration, high intensity, weakly focused field incident on the target medium. The apparatus and methods described herein are particularly suitable for, but not limited to, non-invasive, in-vivo biological assay and disease state indication in target tissue and, more particularly, to potential early detection of Alzheimer's and other diseases.

### CROSS-REFERENCES TO RELATED APPLICATIONS

This application claims priority to U.S. Provisional application Ser. No. 60/987,270 filed on Nov. 12, 2007, the subject matter of which is incorporated by reference herein in its entirety.

### STATEMENT REGARDING FEDERALLY SPONSORED RESEARCH OR DEVELOPMENT

This invention was made with government support under Grant No. 1R21-AG026650 sponsored by the National Institute on Aging, and Grant No. 5-P41EB001976 sponsored by the National Institute of Biological Imaging and Bioengineering, at the National Institutes of Health. The government has certain rights in the invention.

### BACKGROUND OF THE INVENTION

1) Field of the Invention

Embodiments of the invention are most generally related to the field of non-linear optics. More particularly, embodiments of the invention are directed to non-imaging, weakly focused, multiphoton-excited-fluorescence emission and detection, and optical (second) harmonic generation (SHG) apparatus and methods. The apparatus and methods described herein are particularly suitable for, but not limited to, non-invasive, in-vivo biological assay and disease state indication in target tissue and, more particularly, to potential early detection of Alzheimer's and other diseases.

2) Description of the Related Art

Biomolecules and tissue structures that are intrinsically fluorescent accomplish or mediate many crucial biological functions. Clinicians measure and localize the spectra and tissue fluorescence emission from these structures to study and diagnose biological events. The excitation of fluorophores having single-photon absorption in the ultraviolet spectrum with a stream of strongly focused, subpicosecond pulses of red or infrared laser light is typically used to acquire high-resolution fluorescence images of living cells and other microscopic target media. As is known, single-photon fluorescence emission increases with the excitation intensity, however the exciting light may typically photo-bleach the fluorophores during fluorescence excitation with the consequent disadvantages known in the art.

Conventional high-resolution multiphoton microscopy (MPM) fluorescence imaging techniques can and do reduce photo-bleaching and tissue damage over single-photon absorption techniques. Fluorescence and photo-bleaching are ordinarily confined to the immediate vicinity of the focal plane for two-photon excitation. MPM imaging apparatus typically utilize a pulsed illumination laser source having a longer excitation wavelength than required for fluorescence excitation of the material. For example, a fluorophore requiring an excitation wavelength of 500 nm may typically be illuminated by a pulsed laser source at 1000 nm so that single photon excitation does not occur in the specimen, because the fluorophore or dye does not significantly absorb light at 1000 nm The pulsed, high-power excitation illumination, however, provides a sufficiently high photon density within the focal volume for at least two or more lower energy photons to be absorbed by the target medium. The absorption of two or more of these longer wavelength photons provides excitation energy equivalent to the absorption of a single photon of a shorter wavelength, which usually results in excitation confined to the focal volume due to its non-linear nature. That is, in multiphoton excitation, fluorescent material surrounding the focal volume is not excited. The result is that high contrast, high resolution images may be acquired without the need to use pinhole apertures or other spatial filtering elements. Furthermore, the effects of photo-bleaching, photodestruction, and tissue damage that occur from repeated excitation are minimized.

Multiphoton microscopy (MPM) is effective for forming diagnostic in vivo, real-time, three-dimensional images of living biological tissue by nonlinear multiphoton excitation of intrinsic tissue fluorescence. In-vivo images can typically be obtained at depths up to approximately 500 microns (μ) in one to four seconds without significant tissue damage. MPM imaging of intrinsic fluorescence is thus a reliable diagnostic tool used, for example, in the practice of human and animal medicine, but it is limited in its capacity to generate high-resolution tissue images at depths greater than 500μ, which are known to be of interest.

Furthermore, useful detection and imaging of multiphoton excited fluorescence from deep within strongly scattering media, such as, e.g., biological tissues, may be limited by scattering of the incident laser pulses. The high-intensity, short (femtosecond (fs) to picosecond (ps)), focused infrared laser illumination pulses required for multiphoton excitation of fluorescent markers deep in tissues may be scattered strongly enough therein that the quality of the sought-after high spatial resolution multiphoton excited fluorescence images is poor, rendering the images unusable. This scattering can reduce the focused illumination intensity and the focus precision in the focal volume. Moreover, the scattered illumination can be sufficiently bright to excite excessive fluorescence background, thereby further degrading the image quality.

Reported efforts to improve the accuracy of diagnostic measurements and measurements of distributed disease lesions labeled by multiphoton excitable fluorescence are typically directed to noise reduction techniques and reducing collected signal interference.

In view of the aforementioned challenges and shortcomings associated with high-resolution multiphoton fluorescence microscopy imaging apparatus and methods, and others appreciated by those skilled in the art, the inventors have recognized the unfilled need for apparatus and methods that are capable of, and cost effective at, providing the desired target detection and analysis information in a manner that is not susceptible to collection and measurement errors from strongly scattered focused light or other disadvantageous attributes associated with MPM.

### SUMMARY OF CERTAIN DESCRIPTIVE, ILLUSTRATIVE, AND EXEMPLARY EMBODIMENTS OF THE INVENTION

Embodiments of the invention are generally directed to apparatus and methods for determining, detecting, and analyzing an amount of fluorescence (or fluorophore concentration) that is excited by non-imaging fluorescence emission from a target medium. The disclosed apparatus and methods are less susceptible to collection and measurement errors due to scattering and other disadvantageous attributes associated with conventional MPM and SHG imaging techniques, referred to above and as known in the art. As is known, in a conventional multiphoton imaging system, the excitation beam is focused in the target medium and the fluorescence signal is assigned to a microscopic spatial location referred to in the art as the focal volume. The focal volume is typically on the order of one cubic micrometer (1 μm³). In the non-imaging case consistent with the embodiments of the present invention, there is no assignment of the fluorescence signal to any specific target area; rather, the weakly focused excitation beam will create fluorescence emission in a volume of between about 0.1 cm³ to one cubic centimeter (1 cm³), which is significantly larger than the conventional MPM focal volume. The various apparatus and method embodiments of the present invention utilize non-imaging fluorescence detection for target analysis, which may be particularly beneficial for, e.g., providing non-invasive assays of fluorescent indicators of disease states in tissue.

The inventors have recognized that it is not necessary to strongly focus the high intensity excitation illumination in the target medium, as is required to obtain high-resolution images with conventional multiphoton microscopy imaging in order to generate and collect fluorescence-excited or SHG signals; rather, an appropriate weakly focused, larger diameter excitation beam can be used to illuminate a larger area (and focal volume) of the target medium, whereby the quantity of distributed fluorescence emission can be collected and measured with appropriate detection apparatus and correlated with target analysis. In general, beam size (i.e., lateral beam dimension) at the target plane can be approximately equal to or greater than the scattering length of the target tissue (discussed in further detail below), in contrast to the submicron, diffraction-limited focal dimensions required for high-resolution multiphoton microscopy imaging. As used herein, a ‘weakly focused’ beam will mean a beam having a diameter at the target region that is determined by the aforementioned target volume. According to various aspects, the weakly focused beam diameter will be in the range of about 100 microns (μ) to 10 millimeters (mm) Several benefits associated with the use of a suitable larger diameter, weakly focused beam include the ability to increase the excitation beam power, accommodate scattering effects, control the focal volume, and cover a larger target area more efficiently than can be done via conventional MPM and SHG imaging apparatus and techniques.

An embodiment of the invention is directed to a non-imaging, fluorescence emission (i.e., multiphoton or SHG) optical system that is equipped to measure an amount of distributed fluorescence emission, or fluorophore concentration, from or in a target medium. The system includes a target illumination delivery component comprising a suitable light source and delivery optics and electronics for illuminating the target, a control module that provides target illumination beam attributes suitable for generating fluorescence emission from the target medium, and a detector platform configured and positioned to collect a distributed fluorescence emission signal from the target. The system can optionally include appropriate analysis and visualization components for analyzing and displaying the signal and/or signal derived data. According to an exemplary aspect, the target illumination delivery component includes a pulsed target-excitation source such as, but not limited to, a titanium sapphire (Ti:S) laser system. Other suitable and commercially available sources can be used. The control module, in conjunction with the target illumination delivery component, will advantageously provide from 10² to 10⁸ pulses per second having a pulse duration on the order of 100 femtoseconds (fs). Pulse energy will advantageously be between one (1) to 100 microJoules (μJ) per pulse. It will be appreciated that the recited pulse power range is considerably greater than that used in conventional multiphoton microscopy imaging. In order to provide sufficient local multiphoton excitation intensity in a weakly focused beam, the laser pulse energy is increased by an appropriate scaling factor over pulse energies typically used for multiphoton microscopy with a submicron diameter beam focus. In one aspect, the pulse energy is related to the scattering nature of the tissue under investigation, due to possible nonlinear events such as self-focusing. The scaling factor is approximately equal to the ratio of the new illumination cross-sectional area divided by the cross-sectional area of the typical focal volume in MPM imaging, resulting in laser pulse energies on the order of 10⁴ to as much as 10⁸ times higher than for high-resolution multiphoton (MPM) imaging applications. The excitation beam impinging the target plane will be a weakly focused beam. The detector component can be any of a variety of detector types that are suitable for fluorescence emission detection. In an advantageous aspect, the detector component comprises one or more large-area photosensitive detectors that can be positioned proximate the target surface outside of the scattering volume. Such a configuration will accommodate integrated collection of signals distributed over large scattering angles to detect the greatest amount of the fluorescence emission. The detector(s) may suitably employ spectral filters. In an aspect, the target illumination delivery component may comprise a light pipe through which excitation illumination and target-emitted signal are propagated to their respective destinations. According to an exemplary aspect, a detector and/or a spectrometer may be disposed at an output of the light pipe. In an aspect, the system may further comprise an excitation beam scanner. A scanner may be an advantageous system component, for example, when it is desired to assay target volume surfaces that are larger than the weakly focused excitation beam diameter. Such a circumstance may arise, e.g., in the study of inhomogeneous target media.

Another embodiment of the invention is directed to a non-imaging, multiphoton fluorescence emission optical system as outlined above that includes a temporal focus controller. The temporal focus controller is disposed in the excitation beam path to spatially segregate spectral components of the short duration, multichromatic excitation pulse. The spectral components are then recombined and the beam is weakly focused on the target as described above. The temporal focus controller provides focal geometry decoupling of the lateral and axial dimensions of the beam and allows shaping and, particularly confinement, of the focal volume in contrast to a conventional spatial focus in which the lateral spot size essentially determines the axial focal dimension. The interested reader is directed to Zhu, G. H. et al., Optics Express, 13 (6) p. 2153 (2005). The benefits of temporal focusing-induced decoupling include the ability to place an axially loosely confined excitation only at the target region of interest and reduced excitation outside the target volume. According to an exemplary aspect, the temporal focus controller is a dispersive device, such as a grating, a hologram, a prism, or other known component that provides optical dispersion.

Another embodiment of the invention is directed to a method for non-imaging, fluorescence emission from a target and signal detection. According to the method, a non-imaging, weakly focused, pulsed excitation beam is used to illuminate a target medium under conditions effective to cause the target medium to undergo fluorescence emission. The distributed, non-imaging signal emission produced by the target medium is collected and the strength of the collected signal is measured. An application of the method is directed to determining an amount of fluorescence or fluorophore concentration in the target medium. This ability allows us, for example, to measure the concentration of distributed disease lesions labeled by multiphoton excitable fluorescence or SHG deeper in biological tissues than is possible with conventional multiphoton high-resolution imaging apparatus and methods.

Another embodiment of the invention is directed to a method for shaping and/or controlling (confining) the focal volume of a non-imaging, fluorescence emission excitation field in a target medium. The method result is accomplished by decoupling the axial dimension dependence of the focal volume from the lateral spot size of the excitation field, which typically completely determines the axial dimension. The method involves the step of spatially separating at least some of the spectral components of a short duration, multichromatic excitation field outside of the focal volume and spatially recombining the spectral components in a short duration, high intensity, weakly focused field incident on the target medium. According to an aspect, a dispersion-producing device or component is disposed in the path of the excitation field to spatially segregate the spectral components of the field. An appropriate optical system or component is disposed optically downstream of the spectrally dispersed field to spatially and temporally weakly focus the field on the target medium. A grating, prism, or other known optical dispersion means are suitably used. The method is particularly advantageous in the non-imaging, multiphoton fluorescence emission generation and detection applications described herein in light of the weakly focused excitation field that is a principal attribute of the invention embodiments.

A particularly advantageous embodiment of the invention is a non-invasive method for generating diagnostic data potentially indicative of early detection of Alzheimer's disease. In an aspect, the method involves the steps of labeling intact target brain tissue with a suitable dye that binds to amyloid beta (Aβ) aggregates in Alzheimer's disease; illuminating the target brain tissue with a weakly focused, non-imaging excitation field suitable for generating a multiphoton fluorescence emission, or, second harmonic generation emission signal from the target tissue; collecting the signal; and determining the amount of fluorescence emission or SHG emission signal. A suitably advantageous dye will be multiphoton excitable, non-toxic, and designed to emit fluorescence at approximately 690 nm only when persistently bound to Aβ. The dye will be deliverable through the blood-brain barrier following injection in the bloodstream and should be rapidly lost from regions not containing Aβ. A labeling dye that emits fluorescence at approximately 690 nm is advantageous due to the minimal light absorption by hemoglobin and oxyhemoglobin at that wavelength. Other dyes that emit at shorter wavelengths may also suffice despite some absorption by hemoglobin and oxyhemoglobin. These shorter wavelength dyes may be used at shallower depths and may be susceptible to inhomogeneous absorption of signaling fluorescence by microcirculation.

Intrinsic fluorescence of tissue occurring in some disease states can also be assayed by the embodiment of this invention. For example, the fluorescence of the phosphorylated tau protein in neurofibrillary tangles of prefrontal temporal dementia may be detected.

Thus according to an aspect of the present invention, non-imaging, two-photon fluorescence is generated from a target medium by illumination with a very high instantaneous intensity, ultra-short, weakly focused or unfocused, excitation field, in sharp contrast to conventional MPM imaging employing a, diffraction-limited excitation beam focus having a beam waist of less than one micron in diameter. The picosecond or shorter duration, high intensity pulses provide high instantaneous power making it probable that a fluorophore (e.g., a fluorescent dye) in the target material will absorb two long wavelength photons.

The total fluorescence excited by conventional, ‘strongly focused’ multiphoton excitation of a locally uniform distribution of fluorophores is roughly independent of the focal volume because the number of illuminated molecules increases for a larger focal volume at about the same rate that the square of the excitation intensity decreases, thus compensating for a decrease in light intensity. Therefore, the degree of illumination focus does not affect the total fluorescence emission. However, two-photon fluorescence excitation by scattered laser light is limited to a characteristic length based on the distances that the excitation photons travel after scattering during the duration of the laser pulse. Thus two-photon fluorescence excitation by scattered laser photons occurs within limited scattering lengths that are tissue and wavelength dependent, and on the order of 30 to 100μ. With reduced scattering, the background is not excited thereby improving background discrimination and focus precision. According to the embodiments of the present invention, the generated signal is maximized in strongly scattering tissues by avoiding strong focusing with weakly focused, high-energy pulses.

### BRIEF DESCRIPTION OF THE DRAWINGS

The accompanying drawings illustrate various exemplary and illustrative embodiments and aspects of the invention. In the drawings:

FIG. 1 is a schematic drawing of a non-imaging, multiphoton fluorescence emission system in accordance with an illustrative embodiment of the invention;

FIG. 2 is a schematic illustration of the weak excitation beam focusing on a target medium that occurs in a non-imaging, multiphoton fluorescence emission system in accordance with an embodiment of the invention;

FIG. 3 is a schematic illustration of the excitation beam focusing in a target medium that occurs in a conventional high-resolution multiphoton imaging system;

FIG. 4 a schematic drawing of a non-imaging, multiphoton fluorescence emission system in accordance with an alternative exemplary aspect of the invention;

FIG. 5 is a schematic drawing illustrating a target illumination and signal delivery component according to an exemplary aspect of the invention;

FIGS. 6a, 6b) are provided to illustrate the concept and architecture of temporal focusing in accordance with an embodiment of the invention; and

FIG. 7 is a schematic drawing of a non-imaging, multiphoton fluorescence emission system in accordance with an exemplary embodiment of the invention.

### DETAILED DISCUSSION OF CERTAIN DESCRIPTIVE, ILLUSTRATIVE, AND EXEMPLARY EMBODIMENTS OF THE INVENTION

As used herein, the term “fluorescence emission” will be used to refer to multiphoton (particularly, two-photon) fluorescence emission as well as optical second harmonic generation (SHG) from a target medium under conditions suitable to excite such fluorescence emission.

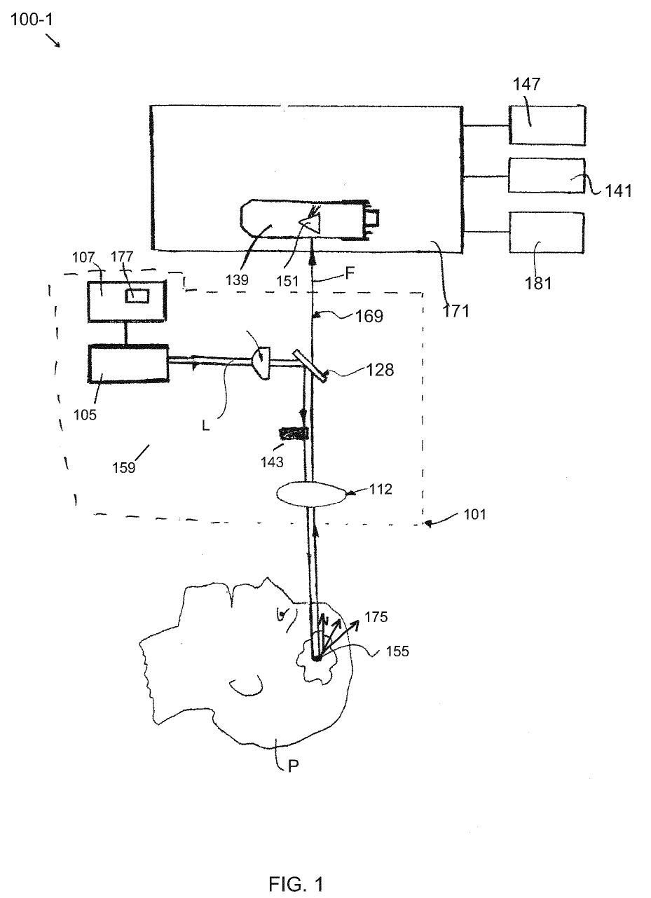

An embodiment of the invention is directed to a non-imaging, multiphoton fluorescence emission optical system that is equipped to measure the amount of distributed fluorescence emission from, or fluorophore concentration in, a target material. An exemplary system 100-1 is shown schematically in FIG. 1 in conjunction with a subject P having intact brain tissue that serves as a target medium 155 in the illustrative application of measuring fluorophore concentration in the target material. The system 100-1 includes a multiphoton excitation light source 105 that provides an output in the form of a suitable target excitation field 111, a light source control module 107 that, in conjunction with a target excitation field delivery component 101 for illuminating the target, provides target excitation field attributes suitable for generating distributed fluorescence emission 175 from the target, and a detector platform 171 that is appropriately configured and positioned to collect the distributed fluorescence emission signal 175 from the target 155.

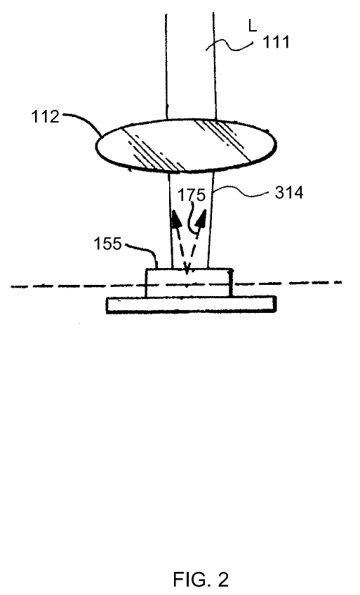

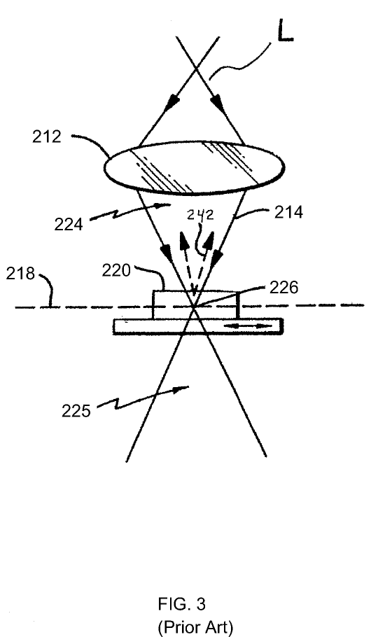

A principal characteristic of the embodiments of the invention is a target excitation field having a weak focus at the excitation region of the target. This is illustrated in FIG. 2 in which the excitation field 111 in the form of laser beam L begins to converge by operation of objective lens 112 on its way to the target 155. The beam 111, however, is not brought to a focus at the target and thus has an on-target beam spot diameter that is significantly larger than the focal spot size in conventional multiphoton imaging, as illustrated in FIG. 3.

As shown in FIG. 3, laser beam L is focused by lens 212 onto target plane 218. The illumination beam 214 fills converging cone 224, and converging cone 224 passes into target material 220 to reach the plane of focus. Except for a fraction of light absorbed by the target material 220, the light beam 214 passes out of the target material 220 through diverging light cone 225. The lens 212 forms a beam waist 226 (or “focal point”) at the object plane 218 of the target material 220, and fluorescence 242 is emitted as target material 220 absorbs two or more photons. The diameter of the beam waist 226 is typically less than about one micron for a diffraction limited beam.

In contrast, the weakly focused beam 111 at the target 155 as shown in FIG. 2 has a diameter equal to or greater than about 100μ. Light energy is absorbed by the target material 155, and fluorescence 175 is emitted as the target material absorbs at least two photons.

In order to excite fluorescence emission according to the embodiments disclosed herein, a suitable excitation source, source control, and beam delivery platform are necessary. According to an exemplary aspect, multiphoton excitation light source 105 illustrated in FIG. 1 is a regeneratively amplified, pulsed titanium sapphire (Ti:S) laser system. In conjunction with the control module, the Ti:S system provides 10² to 10⁸ pulses per second with a picosecond or shorter pulse duration and pulse energy between 1 to 100 μJ per pulse. In a further exemplary aspect, 100 fs pulses were generated at a rate of 80 MHz. In order to provide sufficient local multiphoton excitation intensity in a weakly focused beam, the laser pulse power is increased by an appropriate scaling factor over pulse powers typically used for multiphoton microscopy with a submicron diameter beam. The scaling factor is considered to be approximately equal to the ratio of the new illumination cross-sectional area (e.g., 7500μ²) divided by the cross-sectional area of the typical focal volume in microscopic imaging (e.g., 0.75μ²), resulting in laser pulse energy flux on the order of e.g., 10⁴ to 10⁸ times higher than for high-resolution multiphoton imaging applications. The weakly focused beam thus generates molecular excitation of fluorescent labels of target tissue molecules (or SHG of tissue structures). Other suitable excitation sources can be used in place of the Ti:S laser system.

Control module 107 can provide pulse shape and duration, and power control, spectral phase control, modulation, and other control of the light source 105. Control module 107 may also include a wavelength source control module 177 to adjust and switch wavelengths generated by light source 105. Advantageously, the wavelength of the light source is tunable over the range from about 690 nm to 1300 nm in order to excite multiphoton fluorescence or SHG corresponding to the excitation characteristics of the target medium labels.

As further shown in FIG. 1, the target excitation field delivery component 101 includes a beam expander 165 to expand laser excitation beam 111 to an unfocused or weakly focused large diameter illumination field. Beam expander 165 may also serve to reduce pulse spreading and power loss to facilitate multiphoton excitation of the target material. The beam 111 from the laser source 105 can be transmitted to the field delivery component by optical waveguide 159 or via free space propagation. The beam output from the beam expander 165 strikes dichroic mirror 128, which directs the weakly focused excitation field through objective lens 112. Objective lens 112 can be moveable along the axial direction of the laser beam to vary the focal plane of the excitation beam on the target tissue medium 155. Additional focus adjustment may also be employed to adjust the weak focus or to further alter the excitation beam to a weakly focused field. The weakly focused excitation beam generates fluorescence emission 175 from the target. Additional light sources may also be used to effect fluorescence emission.

The dichroic mirror 128 is selected to reflect the excitation beam wavelengths from the source 105 to the target 155, and to transmit the fluorescence emission wavelengths from the target to the detection module 171 for signal collection and detection. Detection module 171 may include a photomultiplier tube (PMT) 139 or other appropriate detector. Photomultiplier tube 139 may include one or more color filters 151 to detect selected fractions of the fluorescence emission by integrating over a range of emission wavelengths. The color filters 151 and photodetectors are placed outside the scattering volume of target material 155 to enable fluorescence signal integration over the large scattering angles. The system may also include a raster scanner 143 in the excitation path that scans the target material 155 in two dimensions. Detection module 171 may integrate the detection and collection portion and the measurement portion of the measuring function of system 100, or the detection and collection portion and measurement portions may be performed by discrete components. Additionally, a detection control module 181 may be employed to control detection and collection of the fluorescence emission. Additionally, analysis module 147 can be used to determine the fluorophore concentration in the target medium. A computer based video display 141 can be operationally connected to the system to facilitate the examination of collection and analysis parameters for fluorescence analysis and display.

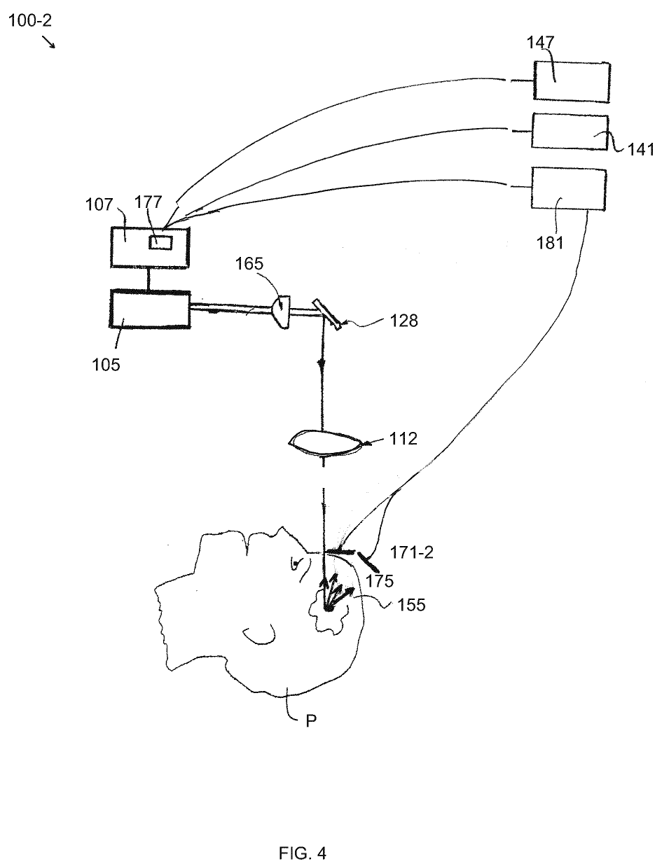

An alternative, exemplary system aspect 100-2 is schematically illustrated in FIG. 4. The system 100-2 is similar to that of system 100-1 except that one or more large area detectors 171-2 are disposed proximate the target to directly collect and detect the distributed fluorescence emission 175. In this set up, then, beam steerer 128 need not be a dichroic component. Detection control module 181, analysis module 147, and video display 141 can still be operationally connected to the system, as desired, in support of their respective functions.

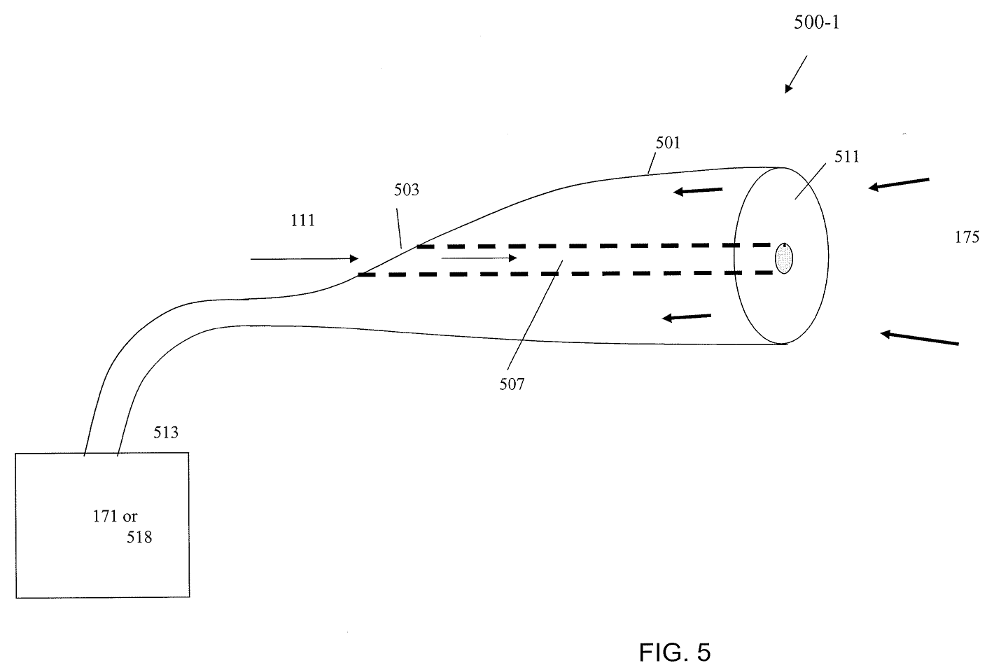

An alternative, exemplary aspect of a target illumination and signal delivery component 500-1 is schematically illustrated in FIG. 5. The component comprises a light pipe 501 (or equivalent structure as known in the art) that includes an excitation beam input port 503 and an excitation beam propagation path 507 for directing the weakly focused excitation beam 111 to a terminal target end 511 of the light pipe. The light pipe further has appropriate optical attributes known in the art that facilitate the collection of fluorescence emission 175 at the terminal end 511 of the light pipe and propagation of the fluorescence emission signal to a signal output end 513 of the light pipe. A detector 171 or a spectrometer 518, for example, can be disposed at the output end 513 for signal detection and analysis. An index matching substance may be used at the target end 511 to facilitate operational engagement of the light pipe with the target surface (not shown). Multiple light pipes may also be used.

Another embodiment of the invention is directed to a non-imaging, fluorescence-emission system that utilizes a weakly focused excitation field as described above and, which, includes a temporal focus controller. The inclusion of a temporal focus controller provides a degree of confinement control over the axial dimension of the focal volume by separating this axial dependence from the lateral spot size of the excitation field, where this parameter determines the axial focal dimension in imaging-based MPM systems. This can also mitigate strong scattering background signal from bone and dura layers. In addition, it can also avoid undesired nonlinear events outside the target volume.

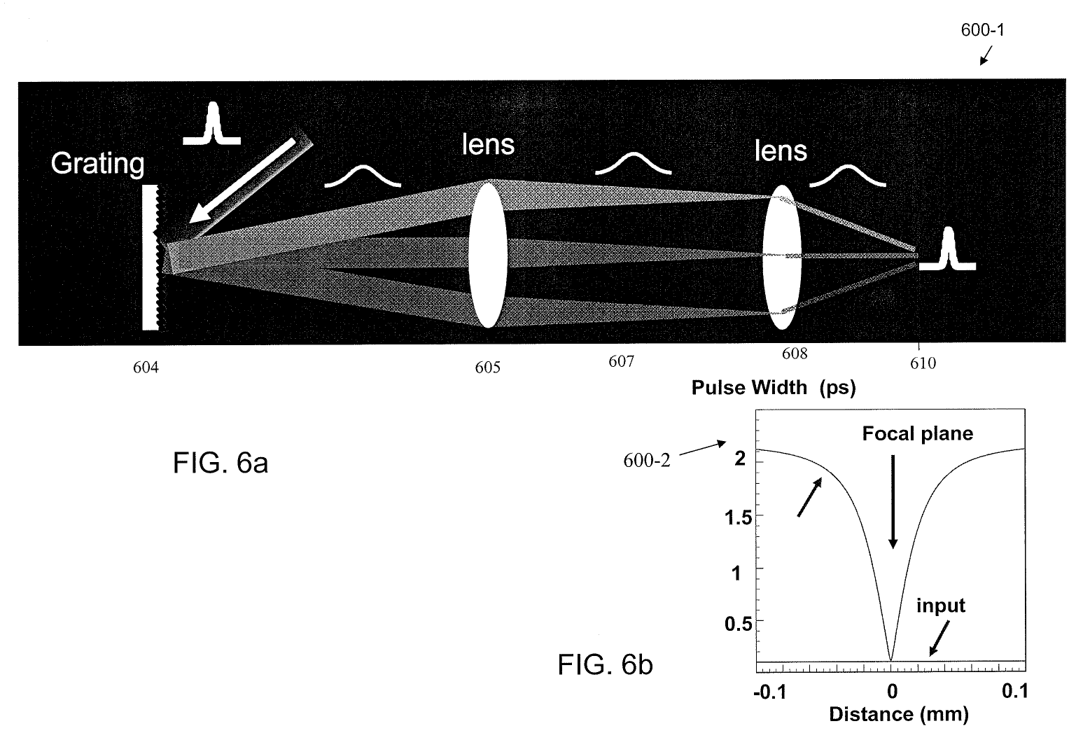

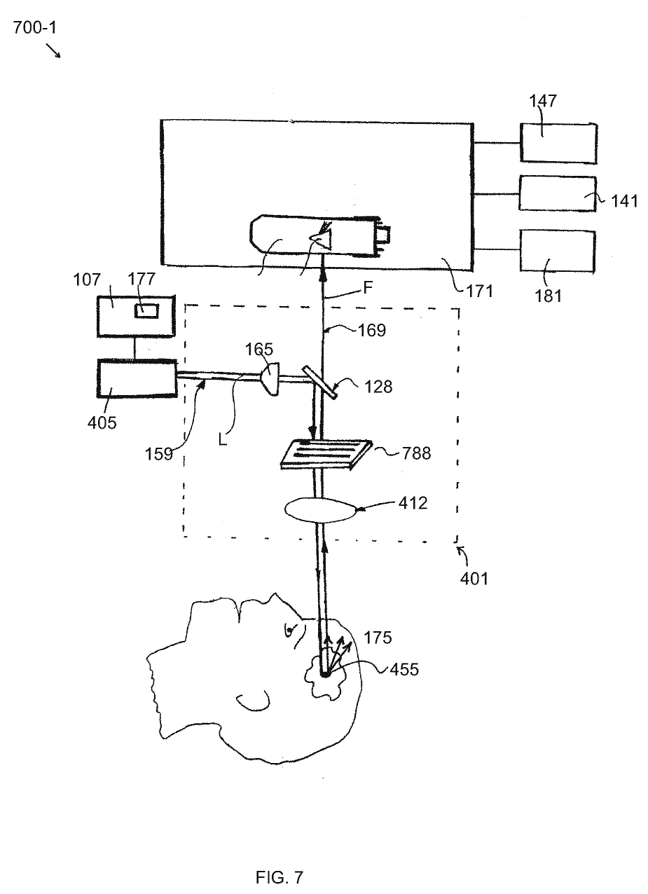

Reference is made to FIGS. 6(a, b) and FIG. 7 to illustrate this aspect of the invention. The concept around temporal focusing and the benefits of simultaneous spatial and temporal focusing (SSTF) involve broadening the pulse width of the excitation field everywhere but at the focal volume. FIG. 6a schematically illustrates the concept and exemplary design architecture 600-1 of SSTF. SSTF works by spatially separating the frequencies (wavelength components) of a short excitation pulse with, e.g., a grating 604 or other appropriate dispersive component, collimating (at 607) these monochromatic beams with a lens 605, and spatially recombining them (at 609) with another lens 608. Because different frequency components of the pulse do not spatially overlap outside the focal region of the lens 608, the pulse width is shortest only at the focal plane 610, achieving a temporal focus. Due to the nonlinear dependence on excitation intensity in multiphoton excitation, pulses with short temporal duration provide more efficient multiphoton excitation than provided by longer pulses. For example, the excitation probability for two-photon excitation is inversely proportional to the excitation pulse width. Clearly, the multiphoton excited signal will peak at the plane where the excitation pulse is the shortest, i.e., the temporal focal plane 610.

FIG. 6b is a plot 600-2 that shows the measured temporal pulse width (in picoseconds) at distances in the range between ±0.1 mm away from the focal plane.

Using SSTF, the inventors have achieved a focal volume axial confinement of 5 mm (FWHM) with a weakly focused excitation beam diameter of approximately 1 cm.

FIG. 7 schematically illustrates an exemplary embodiment of a non-imaging fluorescence emission system 700-1 including a temporal focus controller. The system is identical to the system 100-1 shown in FIG. 1 except that a dispersive device 788 in the form of a diffraction grating is disposed in the propagation path of the excitation beam 111 intermediate the dichroic beamsplitter 128 and the objective lens 112. Accordingly, the spectral content of the excitation pulse from light source 105 is spatially separated by the grating 788 and is then weakly focused in the target volume 155. Although the capability of shaping the effective illumination volume can also be provided by a tighter focus and beam scanning, such as with a line-scanning system, temporal focusing allows much higher incident peak power due to the weak spatial focusing. The data acquisition time of the temporal focusing system 700-1 can be significantly shorter than that from a line-scanning system, for example, thus providing a beneficial advantage for clinical applications. It will be appreciated that the temporal focus control embodiment can likewise be incorporated in the system embodiment 100-2 as illustrated in FIG. 4.

In addition to measurement of intrinsic tissue fluorescence with multiphoton excitation and SHG, it is possible to utilize the fluorescence of drugs to detect their location in tissue. Often, such drugs segregate to particular tissue structures or disease products, such as tumors. Multiphoton excitation can be used to identify them. Many important drugs absorb ultraviolet light to become fluorescent and are, therefore, effectively excited by multiphoton excitation. As a result, all of the advantages of multiphoton excitation of intrinsic tissue fluorescence together with the labeling features provided by the selective segregation or binding of fluorescence drugs are achieved. For example, the principal drug used to treat colitis, 5-amino salicylic acid, can be imaged in all of the layers of living colon tissue explants as the drug is metabolized. It can be located relative to complex tissue structure by imaging tissue autofluorescence due to, e.g., nicotinamide adenine dinucleotide (NADH), flavins, indoleamines, levulinic acid, etc, and other structures such as tau protein aggregates in neuro-filamentary-tangle targets. Fluorescence emission from such intrinsic sources can be observed in vivo within tissues according to embodiments of the invention disclosed herein.

Fluorescent dyes are commonly used in multiphoton microscopy to image properties of cells and tissues. Suitable fluorescent agents include dyes that are excited by multiphoton excitation, such as, organic molecules whose fluorescence intensity or spectra changes when they bind metal ions such as Ca²⁺, Mg²⁺, Zn²⁺, Na⁺ or K⁺ or H⁺.

Dyes that bind to the DNA double helix such as DAPI (4′,6-diamidino-2-phenylindoledihydrochloride) are particularly useful. Fluorescent drugs and selective biological structure labels such as thioflavin analogs can also provide useful diagnostics. Many such dyes are suitable for application in vivo.

Second harmonic generation (SHG) has been demonstrated to be a useful phenomenon for microscopic imaging of cells. Because the illumination conditions required to excite second (or higher) harmonic oscillation in complex tissue are nearly the same as for multiphoton fluorescence excitation, it is possible to take advantage of SHG in tissues such as collagen to complement multiphoton excitation of intrinsic tissue fluorescence. In complex tissues, SHG is frequently radiated through broad angles that make it detectable along with the multiphoton excited fluorescence.

The system and method embodiments of the present invention may be used for a variety of applications. These include, but are not limited to, determining histological and clinical composition, structure, metabolic state, and tissue vitality; non-invasively detecting in-vivo functional response to physiological and pharmacological stimuli and disease states in a subject; and, determining tissue or drug fluorescence excitation and emission spectra, luminosity, fluorescence lifetime, and temporal fluctuations in the target.

The foregoing description of the aspects and embodiments of the present invention provides illustration and description, but is not intended to be exhaustive or to limit the invention to the precise form disclosed. Those of skill in the art will recognize certain modifications, permutations, additions, and combinations of those embodiments are possible in light of the above teachings or may be acquired from practice of the invention.

We claim:

1. A non-imaging, multi-photon fluorescence-emission optical system, comprising:
a target illumination source;
a target illumination control module that is controllable to provide a fluorescence-emitting target illumination to a selected target having a scattering length and a distributed fluorescence emission from a focal volume of between about 0.1 cm³ to about 1 cm³ of an excitation region of the target; and
a detector platform,
wherein the target illumination has a non-diffraction-limited, weakly focused spot size in the excitation region of the target.

2. The system of claim 1, wherein the target illumination weakly focused spot size has a lateral dimension that is on the order of the scattering length of the target.

3. The system of claim 1, wherein the target illumination weakly focused spot size has a lateral dimension that is in a range of between about 100 micrometers to about 10 millimeters.

4. The system of claim 1, wherein the weakly focused target illumination in the excitation region of the target comprises between about 100 to about 1×10⁸ pulses per second.

5. The system of claim 4, wherein each of the pulses has a duration about equal to or less than one picosecond.

6. The system of claim 5, wherein each of the pulses has an energy of between about one microJoule to about 100 microJoule.

7. The system of claim 1, wherein the target illumination delivery component further comprises a waveguide through which the target illumination and the fluorescence emission can propagate to respective destinations.

8. The system of claim 1, further comprising a target illumination scanner disposed in a target illumination optical path.

9. The system of claim 1, further comprising a temporal focus controller disposed in a target illumination optical path.

10. The system of claim 1, wherein the detector platform is in a location non-proximate to the target such that the detector platform can only indirectly detect the fluorescence emission.

11. The system of claim 1, wherein the detector platform comprises a large area detector that is in a location proximate to the target such that the large area detector can directly detect the fluorescence emission.

12. The system of claim 1, wherein the detector platform can generate a signal output that is indicative of an amount of the fluorescence emission.

13. The system of claim 12, wherein the detector platform can generate a signal output that is indicative of a concentration of a fluorophore from the focal volume.

14. A method for generating a non-imaging, distributed, multi-photon fluorescence emission from an excitation region of a target, comprising:
illuminating the excitation region of the target with a plurality of suitable fluorescence emission excitation pulses each having a non-diffraction limited, weakly-focused lateral spot dimension that is approximately equal to or greater than a characteristic scattering length of the target.

15. The method of claim 14, comprising generating the non-imaging, distributed, multi-photon fluorescence emission in a focal volume of between about 0.1 cm³ to about 1 cm³ of the excitation region of the target.

16. The method of claim 14, comprising illuminating the excitation region of the target with a plurality of suitable fluorescence emission excitation pulses each having a non-diffraction limited, weakly-focused lateral spot dimension that is in a range of between about 100 micrometers to about 10 millimeters.

17. The method of claim 17, comprising illuminating the excitation region of the target with between about 100 to about 1×10⁸ pulses per second.

18. The method of claim 17, comprising illuminating the excitation region of the target, wherein each of the pulses has a duration about equal to or less than one picosecond.

19. The method of claim 18, comprising illuminating the excitation region of the target, wherein each of the pulses has an energy of between about one microJoule to about 100 microJoule.

20. The method of claim 14, further comprising scanning the target excitation illumination over the excitation region.

21. The method of claim 14, further comprising weakly temporally focusing the target excitation illumination in the excitation region.

22. The method of claim 14, further comprising directly detecting the non-imaging, distributed, multi-photon fluorescence emission at a location proximate the target.

23. The method of claim 14, further comprising detecting an amount indicative of the strength of the fluorescence emission.

24. The method of claim 14, further comprising detecting an amount indicative of a concentration of a fluorophore from the target volume.
